(19) United States
(12) Patent Application Publication
(10) Pub. No.: US 2008/0086231 A1
(43) Pub. Date: Apr. 10, 2008

(54) System for storing tool assemblies

(76) Inventor: Ju-Young Kim, Cheonan-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/647,077

(22) Filed: Dec. 28, 2006

(30) Foreign Application Priority Data
Oct. 10, 2006 (KR) 10-2006-0098318

(51) Int. Cl. G06F 7/00

(52) U.S. Cl. 700/215

(57) ABSTRACT

A system includes a rail unit, which is provided in the space defined above an automatic palletizing line, a moving unit which moves along the rail unit, a driver for moving the moving unit, and a plurality of tool hangers, which are hung on and supported by the moving unit and have fingers supporting the tool assemblies. The system further includes an ID (identification) card, which is provided in each of the tool hangers and stores therein information about each of the tool assemblies, and a control unit, which has a reader to identify the ID cards and controls the operation of the driver.

### CROSS-REFERENCE TO RELATED APPLICATIONS

The present application is based on, and claims priority from, Korean Application Serial Number 10-2006-0098318, filed on Oct. 10, 2006, the disclosure of which is hereby incorporated by reference herein in its entirety.

### FIELD OF THE INVENTION

The present invention relates to systems for storing tool assemblies and, more particularly, to a system for storing various kinds of tool assemblies to be used in an automatic panel palletizing line that carries panels to pallets.

### BACKGROUND OF THE INVENTION

Generally, to form a vehicle body, a BIW (body-in-white) is manufactured by welding together panels, which have various shapes corresponding to components of the vehicle body and are formed by presses. The pressed panels used in this process are classified into various kinds, for example, a side panel, a roof panel, a door panel, a fender panel, etc.

The various kinds of panels are carried to and stacked on pallets in an automatic palletizing process. Thereafter, the pressed panels are supplied to a welding line and welded together by a welding robot, thereby forming the BIW.

The process of carrying the panels from the automatic palletizing line to the pallets is conducted by a working robot. Various tool assemblies corresponding to the various kinds of panels can be removably mounted to the working robot.

In detail, each tool assembly includes a tool master, which is a connection part to be removably coupled to an arm of the working robot, a support bar, to which the tool master is mounted, and vacuum suction units on the support bar to hold a panel using vacuum suction force.

A different tool assembly is used for each kind of panel. It is difficult to store the tool assemblies, and particularly difficult to find the tool assembly corresponding to a desired panel when necessary.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention efficiently and separately store various kinds of tool assemblies to be used by a working robot during a palletizing process in a space above an automatic palletizing line.

Furthermore, embodiments of the present invention make it possible to easily carry a desired tool assembly to a position at which the tool assembly that has been mounted to the working robot is replaced with the desired tool assembly.

A system for storing tool assemblies according to an embodiment of the present invention includes a rail unit provided in a space defined above an automatic palletizing line. A moving unit moves along the rail unit. A driver moves the moving unit. A plurality of tool hangers is hung on and supported by the moving unit and has fingers to support various kinds of tool assemblies. An ID (identification) card is provided in each of the tool hangers and stores therein information about each of the tool assemblies. A control unit has a reader to identify the ID cards. The control unit controls operation of the driver.

### BRIEF DESCRIPTION OF THE DRAWINGS

For a better understanding of the nature and objects of the present invention, reference should be made to the following detailed description with the accompanying drawings, in which:

FIG. 1 is a view showing the construction of a system for storing tool assemblies, according to an embodiment of the present invention;

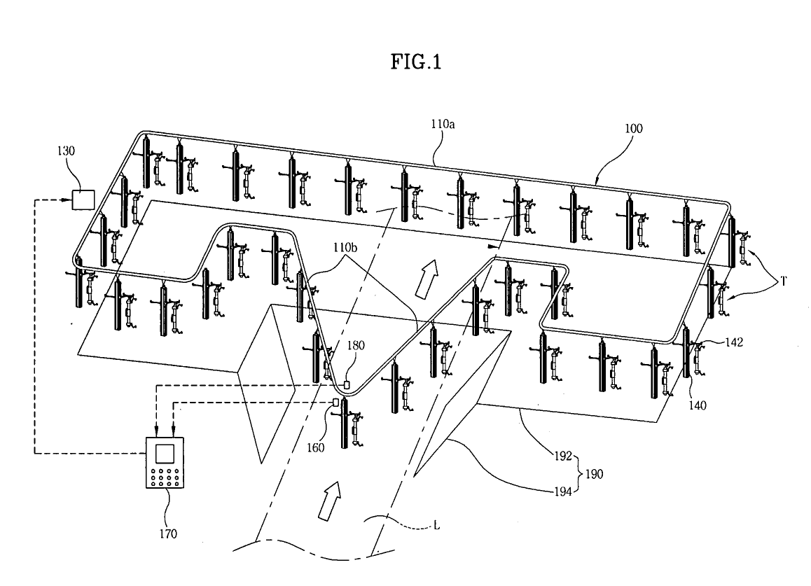

FIG. 2 is a side view of FIG. 1 to show the tool assembly storage system and an automatic loading line provided therebelow;

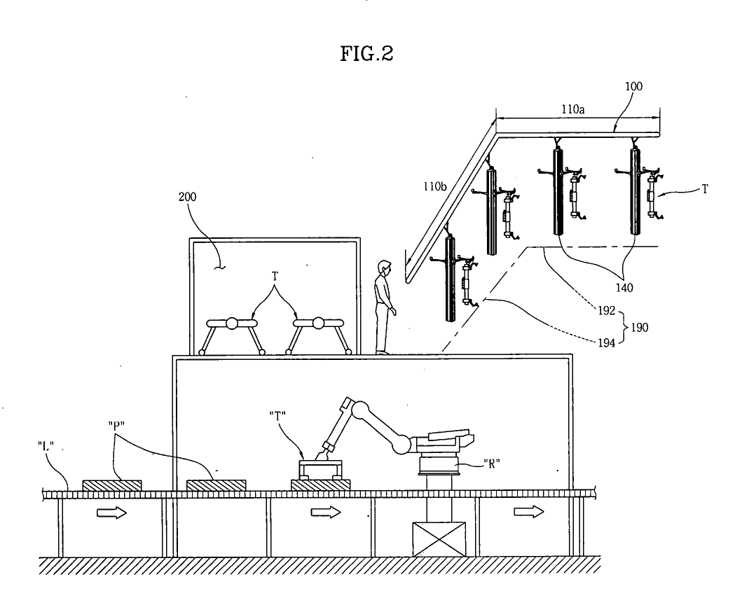

FIG. 3 is a plan view, a side view and a sectional view showing a rail unit and a moving unit, which are shown in FIGS. 1 and 2;

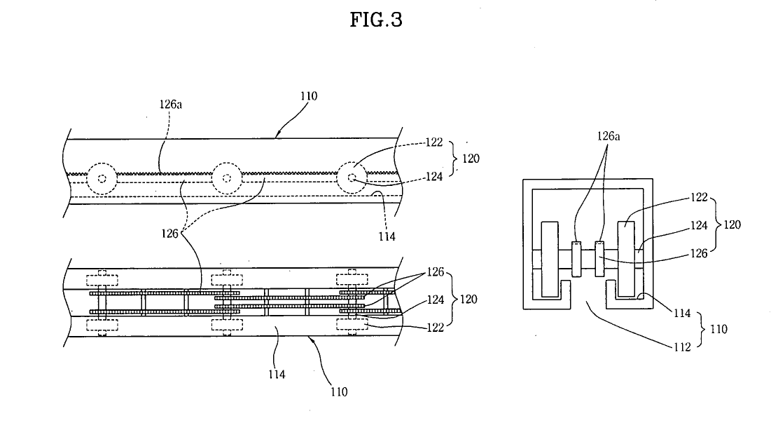

FIG. 4 is a perspective view showing the coupling relationship between the rail unit and a driver according to an exemplary embodiment of the present invention;

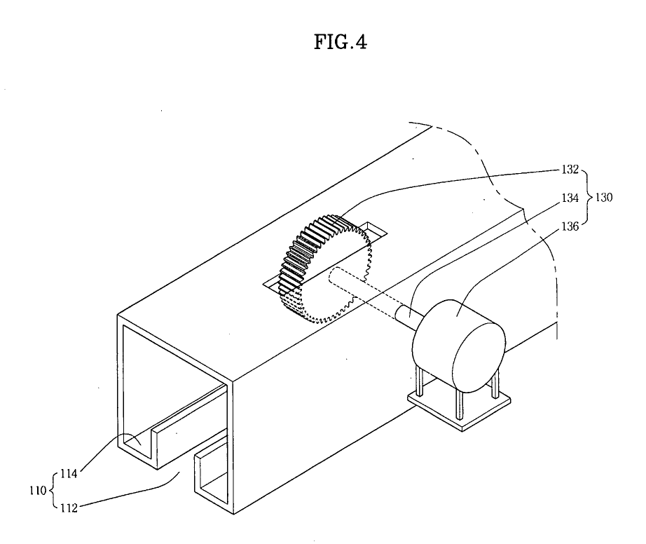

FIG. 5 is a view showing the installation of a tool hanger shown in FIGS. 1 and 2;

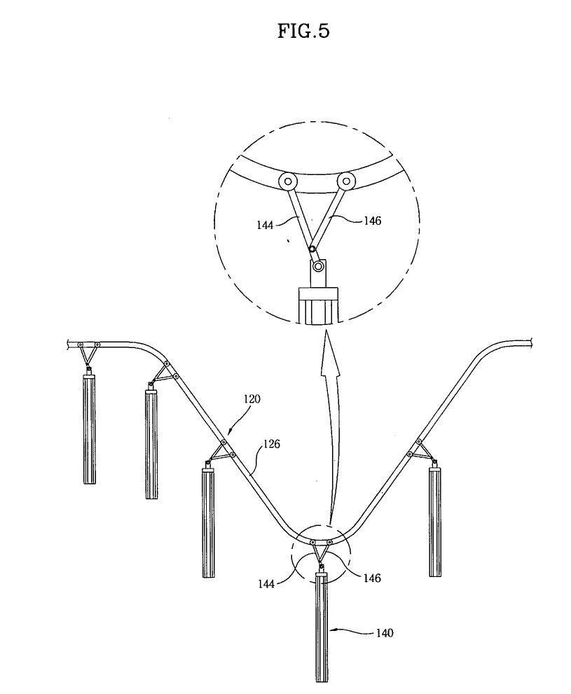

FIG. 6 is a detail view showing the construction of the tool hanger of FIG. 5; and

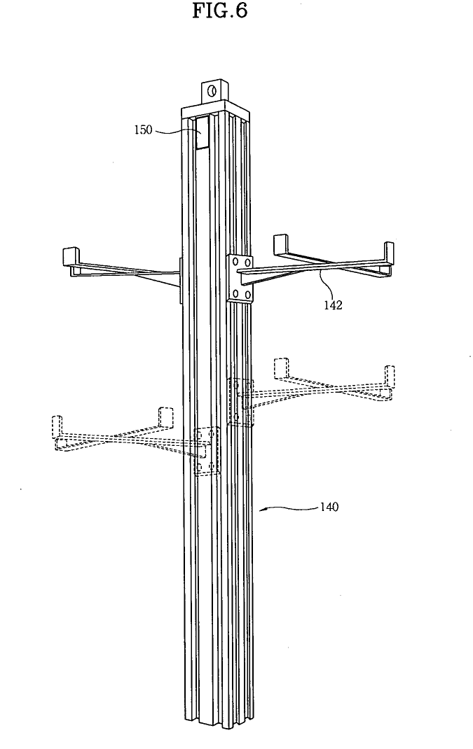

FIG. 7 is a view showing an example of a tool assembly of FIG. 2.

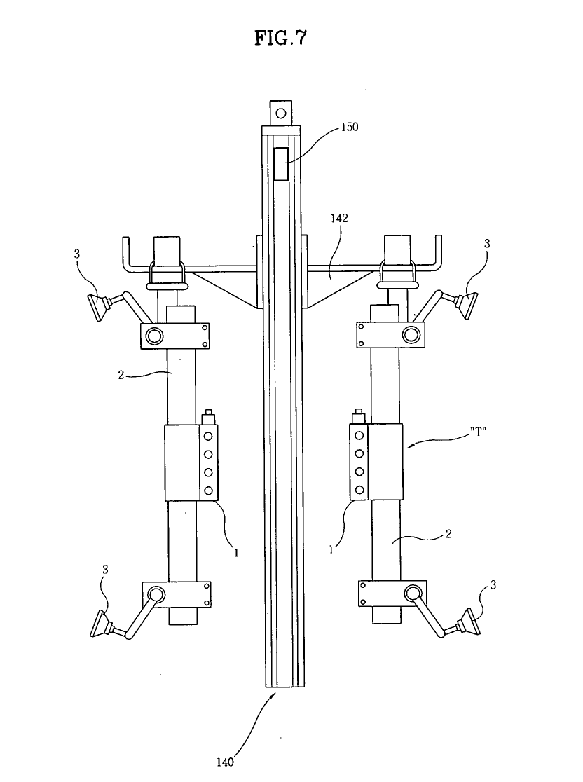

### DETAILED DESCRIPTION OF THE PREFERRED EMBODIMENTS

Hereinafter, embodiments of the present invention will be described in detail with reference to the attached drawings.

As shown in the drawings, a carrier 100, which has a monorail construction that forms an endless track, is provided in a space defined above an automatic loading line L. The carrier 100 has a driver 130 for operation thereof. A plurality of tool hangers 140, which hold tool assemblies T, is supported by the carrier 100.

The automatic loading line L serves to carry various kinds of panels P. The panels P, which are carried on the automatic palletizing line L, are loaded on pallets (not shown) by a working robot R.

The carrier 100 includes a monorail type rail unit 110, which is fastened to a ceiling above the automatic palletizing line L and forms an endless track, and a chain conveyor type moving unit 120, which is moved along the rail unit 110.

The tool hangers 140 are hung on and supported by the moving unit 120. Each tool hanger 140 has a plurality of fingers 142, which are coupled to the tool hanger 140 using screws, so that each tool assembly T is hung on a corresponding finger 142.

Each tool hanger 140 has an ID card 150, which stores information about the corresponding tool assembly T. The information of the ID card 150 is read by a reader 160 and input into a control unit 170, which identifies the tool hanger 140 using the information transmitted from the reader 160.

The control unit 170 controls the driver 130 for operating the moving unit 100.

The rail unit 110 has a slot 112, which is open at the lower surface of the rail unit 110 to form a path for movement of the tool hangers 140, and guide rails 114, which are provided on opposite sides of the slot 112.

The rail unit 110 includes a horizontal circulation line 110a and an inclined moving line 110b, which extends from a section of the circulation line 110a to a predetermined position adjacent to the automatic palletizing line L below the automatic storage room.

The moving unit 120 includes idle rollers 122, which are seated onto and roll along the guide rails 114 on the bottom of the rail unit 110, and a link bar 126, which is coupled to the idle rollers 122 through support shafts 124. A threaded part 126a, which transmits power from the driver 130, is provided on an upper surface of the link bar 126.

The driver 130 includes a drive gear 132, which engages with the threaded parts 126a of the link bars 126, and a step motor 136, which is rotated under the control of the control unit 170 and has an output shaft 134, over which the drive gear 132 is fitted.

Each tool hanger 140 is supported both by a first connection link 144, the ends of which are respectively coupled to the link bar 126 of the moving unit 120 and to the upper end of the tool hanger 140 using pins, and by a second connection link 146, the upper end of which is coupled to the link bar 126 using a pin at a position spaced apart from the connection point at which the upper end of the first link 144 is coupled to the link bar 126, and the lower end of which is coupled to the first link 144 using a pin at a position spaced apart from the connection point at which the lower end of the first link 144 is coupled to the upper end of the tool hanger 140.

The tool hanger 140 is prevented from interfering with the moving unit 120 and other tool hangers 140 when the tool hanger 140 is moved by the moving unit 120 along the circulation line and the inclined moving line of the rail unit 110.

Meanwhile, a limit switch type sensor 180, which detects whether the tool hanger 140 is in a loading or unloading position and transmits this to the control unit 170, is provided adjacent to the lower portion of the inclined moving line 110b of the rail unit 110.

Furthermore, a safety net 190 is provided between the rail unit 110 and the automatic palletizing line L to prevent a tool assembly T from falling onto the automatic palletizing line L if the tool assembly T becomes detached from the tool hanger 140.

The safety net 190 includes a horizontal net 192, which is disposed below the circulation line 110a, and an inclined net 194, which is disposed below the inclined moving line 110b.

An automatic tool change (ATC) rack 200 is provided adjacent to the inclined moving line 110b in a space in which the tool assembly T, which has been mounted to the working robot R, is replaced with another.

The tool assemblies T are used to hold panels. Each tool assembly T includes a tool master 1, which is a connection part that is removably coupled to an arm of the working robot R, a support bar 2, to which the tool master 1 is mounted, and vacuum suction units 3, which are provided on ends of the support bar 2.

The operation of the system for storing the tool assemblies according to an embodiment of the present invention will be described herein below.

When a panel P reaches the working robot R through the automatic palletizing line L, the working robot R holds the panel P using the vacuum suction units 3 of the corresponding tool assembly T, mounted to the arm of the working robot R, and, thereafter, loads the panel P on the pallet.

Subsequently, the panel P is supplied to a welding line, on which a vehicle body is formed using a welding robot.

The tool hangers 140, which are supported by the moving unit 120 of the carrier 100, have various kinds of tool assemblies T. The ID card 150, which is provided in each tool hanger 140, has information about the associated tool assembly T corresponding to each panel P.

Information about the tool assembly T corresponding to each panel P may be directly input into an ID card 150 of a tool hanger 140 by manipulating the control unit 170. Alternatively, when the ID cards 150 are previously set to correspond to the panels P, a tool assembly T corresponding to each panel P may be selected and hung on the finger 142 of the tool hanger 140 having the ID card 150 corresponding to the panel P.

Therefore, while the tool hangers 140 are moved along the rail unit 110, the reader 160 reads the ID cards 150 attached to the tool hangers 140 and outputs the information to the control unit 170, which controls the driver 130 such that, when the desired tool hanger 140 is disposed at the lowermost position of the vertical moving rail 110b of the rail unit 110, the driver 130 is stopped by a signal output from the sensor 180, thus making it possible for a worker to move the tool assembly T supported by the corresponding tool hanger 140 to the ATC rack 200.

Thereafter, the existing tool assembly T is replaced with the tool assembly T, which has been moved to the ATC rack 200, by the operation of the working robot R. The working robot R, which has the replacement tool assembly T, holds the panel P. which has been carried on the automatic palletizing line L, using the vacuum suction unit 3, and loads it on the pallet.

Furthermore, the worker hangs another tool assembly T on the empty tool hanger 140, which is disposed at the lowermost position of the inclined moving line 110b of the rail unit 110, and manipulates the control unit 170 such that the tool assembly T held by the tool hanger 140 is moved to the circulation line 110a of the rail unit 110 and is stored in the storage space.

Because the carrier 100 is able to store many tool assemblies T, the tool assemblies T are prevented from being damaged by contact with other substances, and, when it is desired to replace the tool assembly T with another, the required tool assembly T can be found easily.

As is apparent from the foregoing, in a system for storing tool assemblies according to the present invention, various kinds of tool assemblies can be efficiently and separately stored in a space defined above the automatic palletizing line. Therefore, the tool assemblies are prevented from being damaged by striking each other. Furthermore, when necessary, a desired tool assembly can easily be carried to a position at which a tool assembly, which has been mounted to the working robot, is replaced with the desired tool assembly.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1-2. (canceled)

3. The system as defined in claim 4, wherein the rail unit comprises a slot which is open at a lower surface of the rail unit to form a path for movement of the tool hangers, and guide rails provided on opposite sides of the slot to support the roller thereon.

4. A system for storing tool assemblies, comprising:
a rail unit provided in a space defined above an automatic palletizing line;
a moving unit to move along the rail unit, comprising a roller seated on the rail unit and rolling along the rail unit, and a link bar coupled to the roller though a support shaft;
a driver for moving the moving unit;
a plurality of tool hangers hung on and supported by the moving unit and each comprising at least one finger to support a tool assembly;
an ID (identification) module provided in each of the tool hangers and storing information about the tool assembly; and
a control unit to identify the ID modules and control operation of the driver;
wherein the driver comprises a drive gear engaging with the link bar, and a motor to rotate under control of the control unit and driving the drive gear.

5. The system as defined in claim 3, wherein each tool hanger is supported by a first connection link, a first end of which is coupled to the link bar and a second end of which is coupled to an upper end of the tool hanger, and by a second connection link, an upper end of which is coupled to the link bar, and a lower end of which is coupled to the first link.

6. The system as defined in claim 4, further comprising a sensor to detect and transmit whether the tool hanger is in a loading or unloading position to the control unit.

7. The system as defined in claim 4, further comprising a safety net provided between the automatic palletizing line and the rail unit.

8. The system as defined in claim 4, wherein the rail unit comprises a substantially horizontal line in the space defined above the automatic palletizing line, and an inclined moving line that extends from a section of the substantially horizontal line.

9. The system as defined in claim 8, further comprising a sensor to detect and transmit whether the tool hanger is in a loading or unloading position to the control unit, wherein the sensor is disposed around a lowermost portion of the inclined moving line.

10. The system as defined in claim 8, further comprising a substantially horizontal safety net disposed below the substantially horizontal line, and an inclined safety net disposed below the inclined moving line.

11. The system as defined in claim 8, wherein a lowermost portion of the inclined moving line is disposed adjacent to an automatic tool change rack.
